(19) United States
(12) Patent Application Publication
(10) Pub. No.: US 2025/0341228 A1
(43) Pub. Date: Nov. 6, 2025

(54) Retention Apparatus for Retaining an Add-on Part to a Component for a Motor Vehicle and Arrangement

(71) Applicant: Bayerische Motoren Werke Aktiengesellschaft, Muenchen (DE)

(72) Inventors: Achim DOCKWEILER, Muenchen (DE); Florian MEINDL, Pemmering (DE)

(21) Appl. No.: 18/862,212

(22) PCT Filed: Apr. 11, 2023
(86) PCT No.: PCT/EP2023/059366

§ 371 Date: Nov. 1, 2024

(30) Foreign Application Priority Data
May 2, 2022 (DE) 10 2022 110 614.4

(51) Int. Cl. F16B 21/08; B62D 35/00

(52) U.S. Cl. CPC F16B 21/086; B62D 35/007

(57) ABSTRACT

A retention apparatus for securing an add-on part to a component for a motor vehicle includes a first fastening region, via which the retention apparatus is to be secured to the component, a second fastening region, via which the add-on part is to be secured to the retention apparatus, and a seal element, which is connected to the first fastening region and is designed to bear against the component, and by which the retention apparatus can be sealed with respect to the component.

### BACKGROUND AND SUMMARY

The invention relates to a retention apparatus for retaining an add-on part on a structural element for a motor vehicle. The invention further relates to an arrangement of an add-on part on a structural element which is formed separately from the add-on part for a motor vehicle.

WO 2010/058022 A1 discloses a holder of a motor vehicle add-on part for mounting on a body portion, which is provided with a receiving opening, of a motor vehicle, having at least one securing apparatus for fixing the holder in the region of the receiving opening, wherein the holder having the securing apparatus can be introduced at least in regions from outside the motor vehicle into the receiving opening and the securing apparatus can be actuated from there.

An object of the invention is to provide a retention apparatus for retaining an add-on part on a structural element for a motor vehicle and an arrangement of an add-on part on a structural element which is formed separately from the add-on part for a motor vehicle so that a structural space of the motor vehicle, particularly of the structural element, can be configured in a particularly advantageous manner.

This object is achieved according to the invention by a retention apparatus for retaining an add-on part on a structural element for a motor and by an arrangement of an add-on part on a structural element which is formed separately from the add-on part for a motor vehicle, having the features of the independent claims. Advantageous embodiments of the invention are set out in the dependent patent claims and the description.

A first aspect of the invention relates to a retention apparatus for retaining an add-on part on a structural element, which is particularly formed separately from the add-on part, for a motor vehicle. The motor vehicle is preferably in the form of a motor car, in particular a passenger vehicle, utility vehicle or commercial vehicle. Preferably, the motor vehicle comprises in its completely produced state the add-on part, the structural element and the retention apparatus. This means that, in the completely produced state of the motor vehicle, the add-on part is retained on the structural element by means of the retention apparatus.

For example, the structural element is in the form of a leaf element or a leaf component of the leaf element. The leaf element is, for example, a flap, in particular a rear flap and/or a hood flap. Alternatively, for example, the leaf element is a front flap and/or an engine hood and/or a door. Preferably, the leaf element, particularly in the completely produced state of the motor vehicle, is pivotably retained on a carcass of the motor vehicle. Consequently, in the context of the invention the term “leaf element” may be understood to mean any flap. The leaf element is, for example, pivotable between a closed position and an open position, in particular relative to the carcass. In the closed position, for example, the leaf element closes at least a partial region of a corresponding opening of the carcass, wherein the leaf element releases the partial region in the open position. The opening is preferably an opening of a storage area, in which, for example, transport goods can be stored. The term “carcass” may be understood to mean particularly a, preferably self-supporting, body of the motor vehicle. For example, the leaf element is formed separately from the carcass. Alternatively, the leaf element may be part of the carcass.

Alternatively, for example, the structural element is in the form of the carcass, in particular the self-supporting body. The structural element may be in the form of a carcass component of the carcass as particularly described as a body component.

For example, the add-on part is in the form of an air guiding element of the motor vehicle. The term “air guiding element” may be understood in particular to be an air redirecting element or a spoiler. Alternatively or additionally, the add-on element may be in the form of an air guiding element portion of the air guiding element, in particular a spoiler portion of the spoiler or of a spoiler system.

The retention apparatus has at least one first securing region, via which the retention apparatus is intended to be or is retained on the structural element, in particular directly. In other words, the retention apparatus can be or is secured to the structural element via the first securing region, in particular directly. Preferably, the first securing region of the retention apparatus retained on the structural element touches the structural element directly.

The retention apparatus has at least one second securing region which is particularly different from the first securing region and via which the add-on part is or is intended to be retained on the retention apparatus, in particular directly. In other words, the add-on part can be or is secured to the retention apparatus via the second securing region, in particular directly. This means that the add-on part is intended to be or is retained via the second securing region on the retention apparatus, which in turn is intended to be or is retained on the structural element via the first securing region. Consequently, the add-on part is intended to be or is retained on the structural element via the securing regions, in particular at least indirectly.

Preferably, the add-on part which is retained on the retention apparatus touches the second securing region directly. For example, the second securing region adjoins the first securing region at least indirectly, particularly directly. For example, the securing regions are spaced apart from each other.

The retention apparatus has at least one sealing element which is connected to the first securing region, in particular directly, and which is formed for abutment against the structural element and by means of which the retention apparatus can be sealed against the structural element. In other words, in the installed position of the retention apparatus in the motor vehicle, the sealing element bears against the structural element, in particular directly, wherein the sealing element is provided to seal the retention apparatus against the structural element. This means that, in the completely produced state of the motor vehicle, the retention apparatus is sealed against the structural element by means of the sealing element.

The sealing element is preferably formed from a material which is different from the first and/or second securing region. This means that the first and/or second securing region is/are formed, for example, from a first, particularly respective, material and the sealing element is formed from a second material which is different from the first material.

Preferably, the retention apparatus in the installed position in the motor vehicle is at least mainly arranged at an outwardly directed outer side of the structural element.

The term “outwardly directed outer side” may be understood to mean in particular a side which is directed in the direction of an area surrounding the motor vehicle. Consequently, the outwardly directed outer side is particularly a side which is directed away from an interior of the motor vehicle. Consequently, for example, the retention apparatus is configured for one-sided, in particular external, securing of the add-on part which can be referred to particularly as the securing element.

The invention is based in particular on the following recognitions and considerations: in principle, it is possible in order to be able to particularly advantageously configure a structural space of the motor vehicle, to keep a structural space of the structural element particularly small and, in this instance, for example, to configure the structural element to be particularly flat. Furthermore, it is possible in principle to secure the add-on part to the structural element from an opposite side, in particular from an inner side of the structural element, for example, to screw it. In this case, access for a screwdriver from the opposite side of the add-on part may not be possible or may be able to be afforded only in a particularly complex manner.

Conversely, the structural space of the motor vehicle, in particular of the structural element, may be configured in a particularly advantageous manner by means of the retention apparatus according to the invention, in particular may be kept particularly small. Furthermore, the add-on element can be secured to the structural element from the outer side by means of the retention apparatus according to the invention. This means that in particular no access from the opposite side or from the inner side may be necessary for the securing action. The add-on part can thereby be secured to the structural element in a particularly non-complex manner. Consequently, for example, production complexity of the motor vehicle can be kept particularly low. Furthermore, the structural element can be kept particularly fluid-tight by means of the sealing element of the retention apparatus. This can be brought about, for example, in that a particularly good or a particularly reliable abutment of the sealing element against the structural element can be enabled.

In another embodiment, a first retention member which has the first securing region and a second retention member which is formed separately from the first retention member and which is connected thereto, in particular directly, and which has the second securing region are provided. In other words, the retention apparatus has the first retention member and the second retention member which is formed separately from the first retention member and which is connected to the first retention member, in particular directly, wherein the first retention member comprises the first securing region and the second retention member comprises the second securing region. This means that the retention apparatus is intended to be or is retained on the structural element via the first retention member, in particular directly, and that the add-on part is intended to be or is retained on the retention apparatus via the second retention member, in particular directly. It is thereby possible to keep production complexity of the retention apparatus particularly small. Consequently, for example, production costs of the retention apparatus or of the motor vehicle can be kept particularly small.

Alternatively, the securing regions can be configured together in an integral or one-piece manner. This means that the retention members can be alternatively configured in an integral or one-piece manner and consequently are particularly not configured separately from each other and are not connected to each other.

There is preferably provision for the first retention member to be free from the second securing region. This means that the first retention member does not comprise the second securing region. There is preferably provision for the second retention member to be free from the first securing region. This means that the second retention member does not comprise the first securing region. The sealing element is preferably formed from a material which differs from the first and/or second retention member.

In another embodiment, there is provision for the first securing region to have at least one retention element, by means of which the retention apparatus can be connected to the structural element in a positive-locking manner for retention on the structural element, in particular directly. In other words, the first securing region, in particular the retention element, is provided for forming a positive-locking connection between the retention apparatus and the structural element. Again, in other words, the retention apparatus is intended to be or is retained on the structural element in a positive-locking manner via the first securing region, in particular via the retention element or by means of the retention element. The retention apparatus can thereby be mounted or arranged on the structural element in a particularly non-complex manner, in particular from the outer side. Furthermore, the retention apparatus can be retained on the structural element in a particularly secure manner by means of the positive-locking connection.

There is preferably provision for the retention element to be able to be received in a receiving element of the structural element so as to form a bayonet closure in order to retain the retention apparatus on the structural element. In other words, the first securing region, in particular the retention element, can be secured to the structural element by means of the bayonet closure. This means that the retention apparatus is intended to be or is retained on the structural element, in particular directly, via the first securing region, in particular via the retention element or by means of the retention element, so as to form the bayonet closure or by means of the bayonet closure. Again, in other words, the retention element is formed to form the bayonet closure. Consequently, the add-on part can be or is secured to the structural element by means of the retention apparatus by way of the bayonet closure. It is thereby possible to mount or arrange the retention apparatus on the structural element in a particularly non-complex manner. Furthermore, the retention apparatus can be retained on the structural element in a particularly secure manner.

The term “bayonet closure” may be understood to be in particular a mechanical connection, which can be produced and released, of two, for example, cylindrical components, for example, in the longitudinal axis thereof. The components can be connected to each other by being inserted one in the other and rotated in opposite directions and in this manner also separated again.

Alternatively, the retention apparatus can be screwed or clip-fitted to the structural element via the first securing region.

For example, the structural element has a through-opening, in which the retention apparatus, in particular the first retention member or the first securing region, is or can be received at least in regions. For example, the through-opening comprises the receiving element which is in the form, for example, of an undercut.

In another embodiment, there is provision for the second securing region to have at least one catch element, by means of which the add-on part is intended to be or is retained on the retention apparatus so as to form a catch connection, in particular directly. In other words, the add-on part can be or is secured to the retention apparatus by means of the catch connection via the second securing region, in particular by means of the catch element or via the catch element. This means that the add-on part is intended to be or is retained on the retention apparatus via the second securing region, in particular via the catch element or by means of the catch element. Again, in other words, the second securing region, in particular the catch element, is formed for forming the catch connection between the add-on part and the retention apparatus. It is thereby possible to mount or arrange the add-on part on the retention apparatus in a particularly non-complex manner, in particular via the retention apparatus on the structural element. Consequently, production costs of the motor vehicle can be kept particularly small. Furthermore, the add-on part can be retained on the retention apparatus or on the structural element in a particularly secure manner by means of the catch connection.

Alternatively, for example, the add-on part can be or become secured to the retention apparatus by means of a screwing arrangement or in another manner.

The term “catch connection” may be understood to be in particular a clip-fit. Consequently, the term “catch element” may be understood to be in particular a clip-fit element or a clip. This means that the add-on part can be secured to the retention apparatus or to the structural element by means of the clip-fit.

For example, in that the sealing element is connected to the first securing region, the add-on part can be secured to the retention apparatus by means of the clip-fit independently of the sealing element. It is thereby possible to retain the structural element in a particularly secure and particularly fluid-tight manner, particularly in that the sealing brought about by the sealing element can be ensured, for example, irrespective of a potential slipping or tilting of the catch connection or the catch element.

For example, the catch element is in a first position with the structural element retained on the retention apparatus. This means that the add-on part can be or is secured to the retention apparatus by means of the catch element which is in the first position. For example, the add-on part can be arranged or mounted on the retention apparatus or on the second securing region while the catch element is in a second position which is different from the first position. For example, the add-on part has the through-opening, in which the second securing region or the second retention member is or can be received at least in regions, in particular in order to arrange or mount the add-on part on the retention apparatus. For example, the catch element, in particular a diameter of the catch element, extends in the first position beyond the through-opening of the add-on part, whereby in particular a positive-locking connection between the catch element and the add-on part can be or is brought about. In the second position, the catch element, in particular the diameter of the catch element, does not extend, for example, beyond the through-opening of the add-on part. This means that the diameter of the catch element in the second position is smaller than a diameter of the through-opening of the add-on part. In the second position, for example, no positive-locking connection is or can thereby be brought about by means of the catch element between the add-on part and the catch element. Preferably, the catch element is movable between the positions by, particularly resilient, deformation of the catch element, that is to say, for example, can be moved from the second position into the first position or can be moved from the first position into the second position.

In another embodiment, there is provided at least one support region which is different from the securing regions and via which the add-on part which is particularly retained on the retention apparatus can be or is supported on the retention apparatus, in particular on the first retention member, preferably obliquely or perpendicularly to the axial direction of the retention apparatus. In other words, the retention apparatus, in particular the first retention member, comprises the support region which is provided or formed for, particularly directly, supporting the add-on part on the retention apparatus, in particular on the first retention member. It is thereby possible to retain the add-on part on the retention apparatus in a particularly secure manner, in particular with respect to a mechanical loading which acts on the add-on part.

Preferably, the support region is provided to support the add-on part with respect to a torque which acts on the add-on part on the retention apparatus, in particular on the first retention member. This means that the support region is in the form of a resistance with respect to the torque, with particular respect to a rotation, which is brought about by the torque, of the add-on part. In other words, the torque which acts on the add-on part is or can be supported on the retention apparatus, in particular on the first retention member, via the support region, in particular directly. For example, the torque acts about a rotation axis which extends obliquely or perpendicularly to the axial direction of the retention apparatus. It is thereby possible to retain the add-on part on the retention apparatus in a particularly secure manner. Consequently, the retention apparatus in the form of the support region can have a torque support which causes the add-on part which is intended to be secured to the structural element not to be able to tilt or rotate.

A second aspect of the invention relates to an arrangement of an add-on part on a structural element which is formed separately from the add-on part for a motor vehicle, wherein the add-on part is retained on the structural element via a retention apparatus which has a first securing region, a second securing region which adjoins the first securing region, in particular at least indirectly, and a sealing element, in particular according to the first aspect of the invention. Advantages and advantageous embodiments of the first aspect of the invention shall be considered to be advantages and advantageous embodiments of the second aspect of the invention, and vice versa.

In order to be able to configure a structural space of the motor vehicle, in particular of the structural element, in a particularly advantageous manner, in particular to be able to keep it particularly small, there is provision for the retention apparatus to be retained on the structural element via the first securing region and for the add-on part to be retained on the retention apparatus via the second securing region. The sealing element bears, in particular directly, against the structural element, whereby the retention apparatus is sealed against the structural element. Preferably, the sealing element is connected to the first securing region, in particular directly. There is further provision for the retention apparatus to be arranged at least mainly on an outwardly directed outer side of the structural element, with particular respect to the installation position thereof in the motor vehicle.

In another embodiment, there is provision for the add-on part to be arranged in a rear region of the motor vehicle. In other words, the add-on part is located in a rear part-region of the motor vehicle with respect to a longitudinal vehicle direction of the motor vehicle. It is thereby possible to configure the structural space of the motor vehicle in the rear region in a particularly advantageous manner, in particular to keep it particularly small.

There is preferably provision for the structural element to be in the form of a leaf element of the motor vehicle. The term “leaf element” may be understood in particular to be a flap element which is referred to as a flap. For example, the leaf element or the flap element is in the form of a rear flap of the motor vehicle. In particular, the structural element can be in the form of a rear flap member of the rear flap, wherein the rear flap member can be referred to in particular as a rear flap carcass. It is thereby possible to configure the structural space of the leaf element, in particular of the rear flap, in a particularly advantageous manner, in particular to keep it particularly small.

There is preferably provision for the add-on part to be in the form of an air guiding element, in particular an air redirecting element, and/or a spoiler, of the motor vehicle. The term “spoiler” may be understood in particular to be a spoiler system of the motor vehicle. It is thereby possible, for example, to arrange the air guiding element on the structural element in a manner which is particularly advantageous in terms of structural space and/or in a particularly secure manner.

The term “air guiding element” may be understood to mean in particular a component, which is flowed around or flowed against by air, of the motor vehicle. This means that the air guiding element is arranged, for example, during travel of the motor vehicle in an air flow. The term “air flow” may be understood to mean in particular a travel wind which is brought about by the travel of the motor vehicle and which acts on or flows around the air guiding element.

There is further disclosed a method for arranging an add-on part on a structural element, which is formed in particular separately from the add-on part, by means of a retention apparatus, in particular according to the first aspect of the invention, for a motor vehicle. In the method, the retention apparatus is arranged on the structural element and secured to the structural element via a first securing region of the retention apparatus. A sealing element of the retention apparatus is connected to the first securing region, whereby the sealing element is brought into abutment against the structural element, whereby the retention apparatus is sealed against the structural element. The add-on part is arranged on the retention apparatus, which is secured or retained on the structural element, and secured to the retention apparatus via a second securing region of the retention apparatus. This means that initially the retention apparatus is arranged or secured on the structural element and subsequently the add-on part is arranged or secured on the retention apparatus.

Advantages and advantageous embodiments of the first and second aspect of the invention shall be considered to be advantages and advantageous embodiments of the method, and vice versa.

Additional features of the invention will be appreciated from the claims, the Figures and the description of the Figures. The features and feature combinations mentioned above in the description and the features and feature combinations mentioned below in the description of the Figures and/or set out in the Figures alone can be used not only in the combination set out in each case, but also in other combinations or alone.

The invention will now be explained in greater detail with reference to a preferred exemplary embodiment and the drawings.

### BRIEF DESCRIPTION OF THE DRAWINGS

FIG. 1 is a schematic and perspective view of a retention apparatus according to an embodiment of the invention;

FIG. 2 is a schematic and perspective partially sectioned view of an arrangement according to an embodiment of the invention;

FIG. 3 is a schematic partially sectioned view of an arrangement according to another embodiment of the invention; and

FIG. 4 is a schematic partially sectioned view of an arrangement according to another embodiment of the invention.

In the figures, identical or functionally identical elements are referred to with the same reference numerals.

### DETAILED DESCRIPTION OF THE DRAWINGS

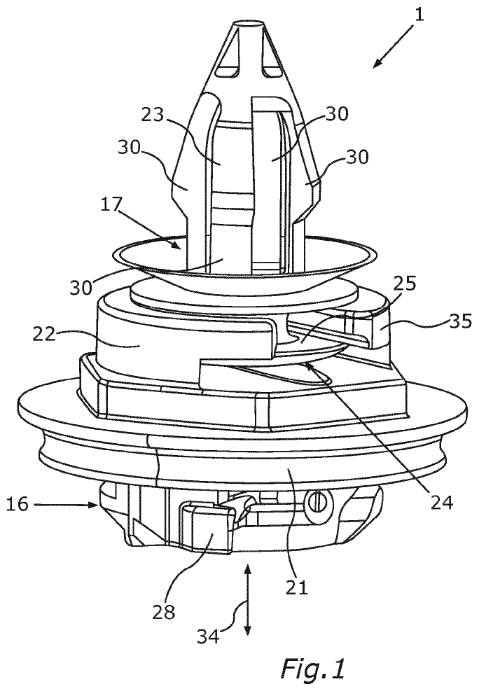

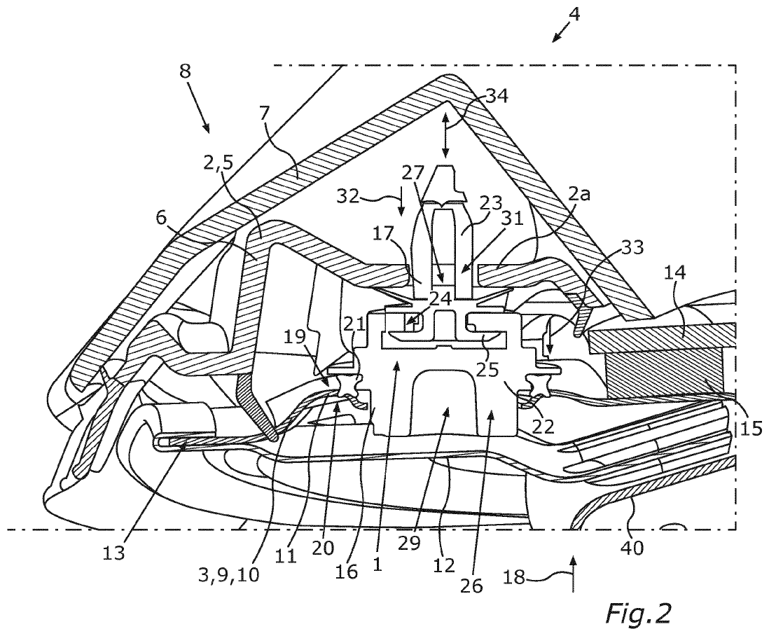

FIG. 1 shows a schematic, perspective view of a retention apparatus 1 for retaining an add-on part 2 on a structural element 3, which is formed in particular separately from the add-on part, for a motor vehicle. FIG. 2 shows a schematic and perspective partially sectioned view of an arrangement 4 of the add-on part 2 on the structural element 3.

In the exemplary embodiment, the add-on part 2 is in the form of an air guiding element 5, in particular an air redirecting element, of the motor vehicle. For example, the air guiding element 5 is in the form of a spoiler or a spoiler system. In the exemplary embodiment shown in FIG. 2, the air guiding element 5 has a first air guiding element portion 6 and a second air guiding element portion 7 which is formed in particular separately from the first air guiding element portion 6 and which is connected to the first air guiding element portion 6. For example, the add-on part 2 is arranged in a rear region 8 of the motor vehicle. The air guiding element 5 can be referred to in particular as an “aero” element or as an aerodynamic element.

Preferably, the structural element 3 is in the form of a leaf element 9. In the exemplary embodiment shown in FIG. 2, the structural element 3 or the leaf element 9 is in the form of a rear flap 10 of the motor vehicle. For example, the leaf element has a first leaf element portion which is in particular in the form of a first rear flap member 11 and a second leaf element portion which is formed in particular separately from the first leaf element portion and which is connected to the first leaf element portion or the first rear flap member 11 and which is in particular in the form of a second rear flap member 12. For example, the rear flap members 11, 12 are connected to each other in an overlap region 13, in particular directly, preferably in a planar manner.

For example, the structural element 3, in particular the first rear flap member 11 and/or the second rear flap member 12, is/are in the form of a metal sheet. For example, the first rear flap member 11 is in the form of an external metal sheet of the rear flap 10. For example, the second rear flap member 12 is in the form of an internal metal sheet of the rear flap 10.

In the exemplary embodiment shown in FIG. 2, a disk 14, in particular referred to as a rear disk, is secured, in particular directly, to the structural element 3, in particular to the leaf element 9 or the rear flap 10, for example, to the first rear flap member 11. For example, the disk 14 is adhesively bonded to the structural element 3, in particular to the first rear flap member 11. This means that the disk 14 is connected to the structural element 3, in particular to the first rear flap member 11, by means of adhesive 15.

The retention apparatus 1 has a first securing region 16 and a second securing region 17 which adjoins, at least indirectly, the first securing region 16. The retention apparatus 1 is intended to be or is retained on the structural element 3, in particular directly, via the first securing region 16. In other words, the retention apparatus 1 and the structural element 3 are or can be connected to each other via the first securing region 16, in particular directly. Via the second securing region 17, the add-on part 2 is intended to be or is retained on the retention apparatus 1, in particular directly. In other words, the add-on part 2 and the retention apparatus 1 are or can be connected to each other via the second securing region 17, in particular directly. The retention apparatus 1 is arranged, with particular respect to the installation position thereof in the motor vehicle, at least mainly at an outwardly directed outer side 19, which is particularly directed upwardly in the vertical vehicle direction 18 of the motor vehicle, of the structural element 3, in particular of the first rear flap member 11.

A structural space of the motor vehicle, in particular of the structural element 3, can be configured particularly advantageously by means of the retention apparatus 1, in particular kept particularly small. In particular, the retention apparatus 1 or the add-on part 2 can be secured or mounted on the structural element 3 from the outer side 19. It is thereby possible to bring about a particularly non-complex assembly, whereby, for example, production complexity of the motor vehicle can be kept particularly small. In this case, the retention apparatus 1 is particularly advantageous, in particular in the case of particularly restricted access from a side, which faces away from the outer side 19 and which is referred to in particular as the opposite side 20, of the structural element 3, in particular of the first rear flap member 11. It is thereby possible to secure the add-on part 2 to the structural element 3 by means of the retention apparatus 1 in the case of the particularly restricted access. This means that the structural space of the structural element 3 does not have to be optimized, for example, with regard to the accessibility thereof from the opposite side 20, whereby the structural space of the structural element 3 can be configured in a particularly advantageous manner, in particular can be kept particularly small.

In the exemplary embodiment shown in FIG. 2, the retention apparatus 1 is retained or secured on the first rear flap member 11 via the first securing region 16, in particular directly. Furthermore, in the exemplary embodiment, the add-on part 2 is retained or secured on the first air guiding element portion 6, in particular directly, via the second securing region 17.

The retention apparatus 1 has a sealing element 21 which is connected, in particular directly, to the first securing region 16 and which is formed for abutment against the structural element 3, in particular the first rear flap member 11, wherein the retention apparatus 1 can be sealed against the structural element 3, in particular against the first rear flap member 11, by means of the sealing element. Consequently, the sealing element 21 which bears against the structural element 3, in particular the first rear flap member 11, is retained on the structural element 3, in particular on the first rear flap member 11, whereby the retention apparatus 1 is sealed against the structural element 3, in particular against the first rear flap member 11. It is thereby possible to keep the structural element 3 particularly fluid-tight.

In another embodiment, the retention apparatus 1 has a first retention member 22 which comprises the first securing region 16 and a second retention member 23 which is formed separately from the first retention member 22 and which is connected thereto and which comprises the second securing region 17. This means that the retention apparatus 1 may be formed in several pieces, in particular in two pieces. For example, the first retention member 22 has a receiving region 24 in which a partial region 25 of the second retention member 23 is or can be arranged in order to connect the retention members 22, 23, in particular in a positive-locking manner.

In the exemplary embodiment shown in FIG. 2, the structural element 3, in particular the first rear flap member 11, has a through-opening 26 which is referred to in particular as the first through-opening 26 and in which the first retention member 22, in particular the first securing region 16, is arranged or received in regions. In the exemplary embodiment, the add-on part 2, in particular the first air guiding element portion 6, has a through-opening which is referred to in particular as the second through-opening 27 and in which the second retention member 23, in particular the second securing region 17, is arranged or received in regions. In particular, the retention apparatus 1 can be introduced from the outer side 19, that is to say, from outside the motor vehicle, into the first through-opening 26 at least in regions. For example, the through-opening is arranged in a portion 2a, which is particularly referred to as the first portion 2a, of the add-on part 2, in particular the first air guiding element portion 6.

In another embodiment, there is provision for the first securing region 16 or the first retention member 22 to have a retention element 28, by means of which the retention apparatus 1 is or can be connected to the structural element 3, in particular to the first rear flap member 11, for retention on the structural element 3 in a positive-locking manner. In this case, there is preferably provision for the retention element 28, for retention of the retention apparatus 1 on the structural element 3, to be received or able to be received in a receiving element of the structural element 3, in particular of the first rear flap member 11, so as to form a bayonet closure 29. The retention element 28 and the receiving element are preferably configured to correspond to each other. For example, the receiving element is in the form of a sheet metal cutout.

In another embodiment, there is provision for the second securing region 17 or the second retention member 23 to have at least one catch element 30, by means of which the add-on part 2, in particular the first air guiding element portion 6, is intended to be or is retained on the retention apparatus 1 so as to form a catch connection 31. In the exemplary embodiment shown in FIG. 2, there are provided a plurality of catch elements, in particular four catch elements, by means of which the add-on part 2 is intended to be or is retained on the retention apparatus 1 so as to form a respective catch connection 31.

For example, the add-on part 2, in particular the first air guiding element portion 6, is or can be supported, preferably directly, in a support direction 32 which can be referred to in particular as the first support direction 32, in particular via the first portion 2a, on the retention apparatus 1, in particular on the second retention member 23, for example, on the second securing region 17 and/or on a face which bears directly against the second securing region 17. For example, the retention apparatus 1, in particular via the first retention member 22, for example, via the first securing region 16 and/or a face which bears directly against the first securing region 16, is or can be supported, in particular directly, on the structural element 3, in particular on the first rear flap member 11, in a support direction 33 which is referred to in particular as the second support direction 33. Preferably, the support directions 32, 33 extend parallel with each other. Preferably, the first support direction 32 and/or the second support direction 33 extend(s) in the axial direction 34 of the retention apparatus 1, in particular of the first retention member 22 and/or of the second retention member 23. For example, the axial direction 34 and/or the first support direction 32 and/or the second support direction 33 extend(s) in the vertical vehicle direction 18 or obliquely relative to the vertical vehicle direction 18. For example, the first and/or second support direction 32, 33 extend(s) downwardly in the vertical vehicle direction 18.

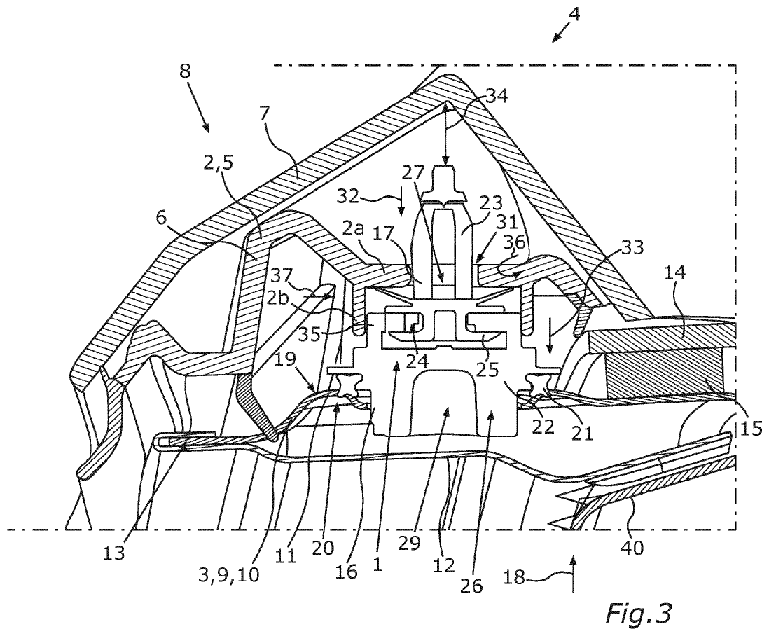

FIG. 3 shows the arrangement 4 or the retention apparatus 1 as a schematic partially sectioned view according to another embodiment. In the embodiment shown in FIG. 3, there is provided at least one support region 35 which is different from the securing regions 16, 17 and via which the add-on part 2, which is retained in particular on the retention apparatus 1, in particular the first air guiding element portion 6 is or can be supported, for example, directly, on the retention apparatus 1, preferably on the first retention member 22. Preferably, the second retention member 22 comprises the support region 35.

Preferably, the add-on part 2, in particular the first air guiding element 6, has a second portion 2b which particularly projects from the first portion 2a. Preferably, the second portion 2b bears, at least indirectly, in particular directly, against the first portion 2a. The portions 2a, b can be formed integrally together or configured separately from each other and connected to each other. For example, the add-on part 2, which is retained in particular on the retention apparatus 1, in particular the first air guiding element portion 6, is or can be supported on the support region 35 or on the retention apparatus 1, in particular on the first retention member 22, via the second portion 2b. Preferably, the second portion 2b touches the support region 35 directly. The second portion 2b can in particular be referred to as a flap.

For example, the support region 35 and in particular the second portion 2b is provided to support a torque 36 which acts on the add-on part 2, in particular the first air guiding element portion 6, whereby the support region 35 can be referred to in particular as the torque support. Consequently, the occurring torque 36 can be supported via the second portion 2b on the support region 35.

For example, the add-on part 2, in particular via the second portion 2b, is or can be supported on the support region 35 in a support direction 37, in particular directly. For example, the support direction 37 extends obliquely or perpendicularly to the axial direction 34 of the retention apparatus 1, in particular of the first and/or second retention member 22, 23. Alternatively, the support direction 37 can extend parallel with the axial direction 34. The add-on part 2 may be supported or able to be supported via the second portion 2b and/or via the support region 35, in particular directly, in a vertical vehicle direction 18, in particular downwardly or obliquely or perpendicularly to the vertical vehicle direction 18, for example, in the longitudinal vehicle direction or in the transverse vehicle direction of the motor vehicle.

For example, the bayonet closure 29 is configured so that the retention element 28 is centered or positioned in the receiving element of the structural element 3, in particular by securing by means of rotation, preferably precisely, in particular obliquely or perpendicularly to the axial direction 34. This means that the retention apparatus 1 is or can be fixed to the structural element 3 in a defined manner via the retention element 28, in particular obliquely or perpendicularly to the axial direction 34. The, in particular precise, positioning can be used to position the add-on part 2 which is intended to be secured to the structural element 3, in particular before securing or during securing, relative to the structural element 3, preferably by means of the second portion 2b. Consequently, a positioning, which is referred to in particular as component positioning or orientation, of the add-on part 2 relative to the structural element 3 can be brought about by means of the second portion 2b and in particular by means of the retention element 28. It is thereby possible to dispense with an additional component, for example, a centering pin, which is provided for the relative orientation of the add-on part 2 and the structural element 3 relative to each other, in particular with a separate seal.

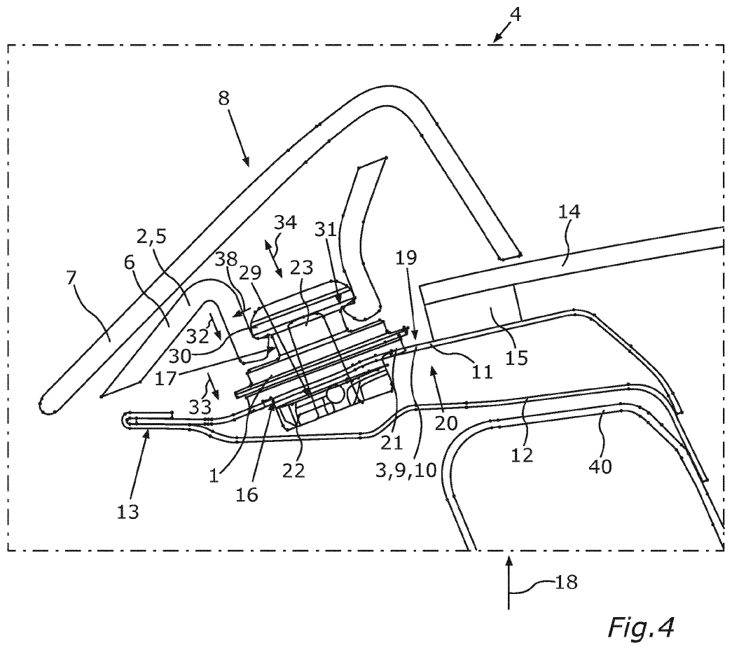

FIG. 4 shows the arrangement 4 as a schematic, partially sectioned view according to an additional embodiment. The embodiment shown in FIG. 4 differs from the embodiment shown in FIG. 2 or FIG. 3, respectively, with particular regard to the catch connection 31. In the embodiment shown in FIG. 4, the add-on part 2 is or can be supported via the respective catch element 30 in the first support direction 32 and in a third support direction 38, in particular directly, wherein the third support direction 38 preferably extends obliquely or perpendicularly to the first support direction 32.

For example, the rear flap 10 comprises a third rear flap member 40 which is formed separately from the rear flap members 11, 12 and which is, for example, in the form of a frame of the rear flap 10. The third rear flap member 40 is connected to the second rear flap member 12, in particular directly.

### LIST OF REFERENCE NUMERALS

1 Retention apparatus
2 Add-on part
2a First portion
2b Second portion
3 Structural element
4 Arrangement
5 Air guiding element
6 First air guiding element portion
7 Second air guiding element portion
8 Rear region
9 Leaf element
10 Rear flap
11 First rear flap member
12 Second rear flap member
13 Overlap region
14 Disk
15 Adhesive
16 First securing region
17 Second securing region
18 Vertical vehicle direction
19 Outer side
20 Opposite side
21 Sealing element
22 First retention member
23 Second retention member
24 Receiving region
25 Partial region
26 First through-opening
27 Second through-opening
28 Retention element
29 Bayonet closure
30 Catch element
31 Catch connection
32 First support direction
33 Second support direction
34 Axial direction
35 Support region
36 Torque
37 Support direction
38 Third support direction
40 Third rear flap member

1.-10. (canceled)

11. A retention apparatus for retaining an add-on part on a structural element for a motor vehicle, comprising:
a first securing region, via which the retention apparatus is configured to be retained on the structural element;
a second securing region, via which the add-on part is configured to be retained on the retention apparatus; and
a sealing element which is connected to the first securing region and which is formed for abutment against the structural element, and by which sealing element the retention apparatus is sealable against the structural element.

12. The retention apparatus according to claim 11, further comprising:
a first retention member which has the first securing region; and
a second retention member which is formed separately from the first retention member and which is connected thereto and which has the second securing region.

13. The retention apparatus according to claim 11, wherein
the first securing region has a retention element, by which the retention apparatus is connectable to the structural element in a positive-locking manner for retention on the structural element.

14. The retention apparatus according to claim 13, wherein
the retention element is received in a receiving element of the structural element so as to form a bayonet closure in order to retain the retention apparatus on the structural element.

15. The retention apparatus according to claim 11, wherein
the second securing region has a catch element, by which the add-on part is to be retained on the retention apparatus so as to form a catch connection.

16. The retention apparatus according to claim 11, further comprising:
at least one support region which is different from the first and second securing regions, and via which the add-on part is supportable on the retention apparatus.

17. An arrangement, comprising:
an add-on part;
a structural element for a motor vehicle, which structural element is formed separately from the add-on part;
a retention apparatus by which the add-on part is retained on the structural element, the retention apparatus having a first securing region, a second securing region which adjoins the first securing region, and a sealing element, and
wherein the retention apparatus is retained on the structural element via the first securing region,
wherein the add-on part is retained on the retention apparatus via the second securing region,
wherein the sealing element bears against the structural element, whereby the retention apparatus is sealed against the structural element, and
wherein the retention apparatus is arranged at least mainly on an outwardly directed outer side of the structural element.

18. The arrangement according to claim 17, wherein
the add-on part is arranged in a rear region of the motor vehicle.

19. The arrangement according to claim 17, wherein
the structural element is a leaf element of the motor vehicle.

20. The arrangement according to claim 17, wherein
the add-on part is an air guiding element of the motor vehicle.
